(19) United States
(12) Patent Application Publication
(10) Pub. No.: US 2016/0035465 A1
(43) Pub. Date: Feb. 4, 2016

(54) CABLE HAVING SYNTHETIC TENSILE MEMBERS

(71) Applicant: Aetna Insulated Wire LLC, Virginia Beach, VA (US)

(72) Inventors: Richard Williamson, Norfolk, VA (US); Howard Jackson, Virginia Beach, VA (US); Greg Smith, Virginia Beach, VA (US); Walt Smith, Virginia Beach, VA (US)

(21) Appl. No.: 14/813,918

(22) Filed: Jul. 30, 2015

Related U.S. Application Data
(60) Provisional application No. 62/030,660, filed on Jul. 30, 2014.

(51) Int. Cl. H01B 17/02; H01B 3/30; H01B 7/18; H01B 3/44

(52) U.S. Cl. CPC H01B 17/02; H01B 3/443; H01B 3/307; H01B 7/1865

(57) ABSTRACT

A cable includes a core and a braided synthetic tensile material. The tensile material is adapted to form a tensile member so as to longitudinally support the core when the cable is used in vertical applications. The tensile member may generally surround the core or be part of the core.

This application claims priority to U.S. Provisional Patent Application No. 62/030,660, filed Jul. 30, 2014, the entire contents of which are hereby incorporated by reference.

### FIELD OF THE INVENTION

The present invention relates generally to electrical, electronic or communication cables and, in particular, to synthetic tensile members for supporting such cables in generally vertical passageways.

### BRIEF DESCRIPTION OF THE DRAWINGS

FIG. 1 is a cutaway, perspective view of a cable designed for installation in generally vertical passageways;

FIG. 2 is a perspective sectional view of a first embodiment of the cable having synthetic tensile members of the present invention.

FIG. 3 is a perspective sectional view of a second embodiment of the cable having synthetic tensile members of the present invention.

FIG. 4 is a perspective sectional view of a third embodiment of the cable having synthetic tensile members of the present invention.

### DETAILED DESCRIPTION OF EMBODIMENTS

From time to time, it is necessary to install cables in a vertical application where the length of the cable being installed, the cable construction or the physical circumstances of the installation require that the cable include dedicated construction members for either temporarily or permanently supporting the cable length. Historically the cable weight has been supported by a number of different techniques including:
a) steel wire armor helically applied to the cable and used to support the weight;
b) messenger wire lashed to the cable for supporting the weight; and/or
c) the use of High Tensile strength members integrated into the design of the cable core and the core covered with a layer of interlocking steel or aluminum armor. The cable is constructed so that the armor “locks” the components in place by restricting radial movement and an untwisting of the core.

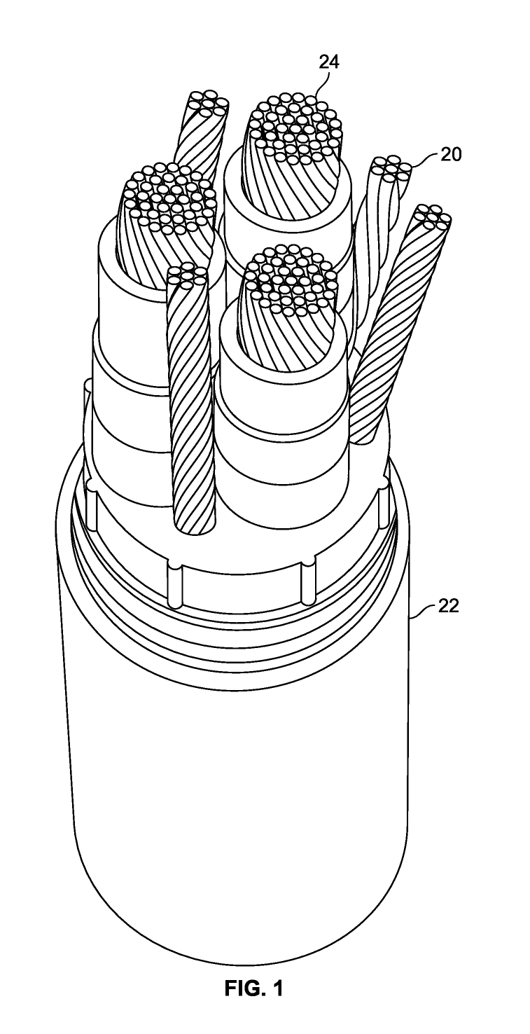

With reference to FIG. 1, cables specifically designed for vertical applications may feature tensile members that are used to lift the cable through a generally vertical passageway. An example of such a cable is presented in FIG. 1, where the tensile members 20, typically constructed of steel, are enclosed within the cable outer jacket 22 along with conductors 24. Conductors 24 may be replaced with members suitable for non-power applications, such as data and communication.

As greater and greater depths are addressed and cables get longer and longer, the weight of the steel tensile members precludes their use. The steel weight makes the cables heavier and so larger tensile members are needed adding to its weight until there is no room left for any payload.

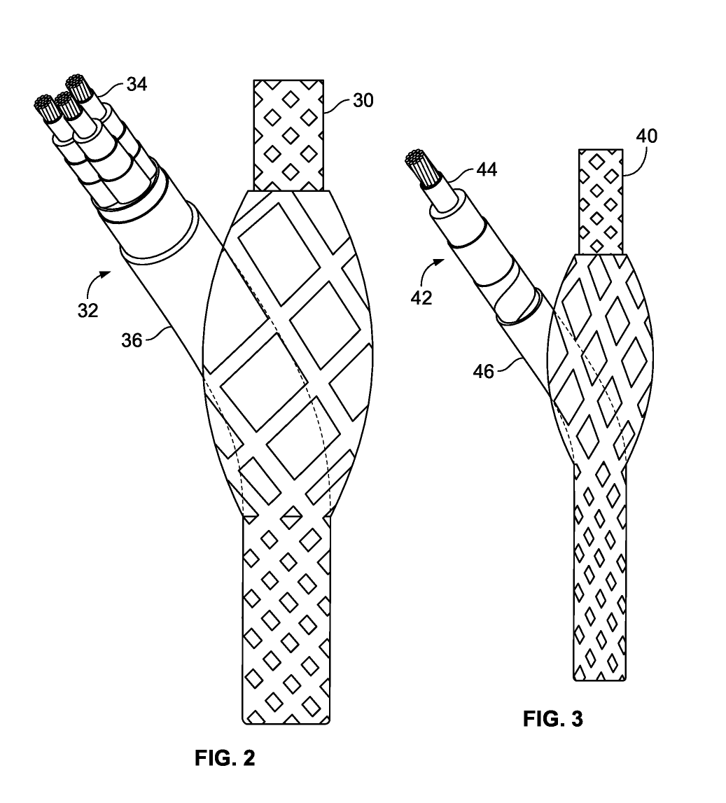

In the embodiments of the cable of the invention illustrated in FIGS. 2 and 3, the individual steel tensile members (20 of FIG. 1) are replaced by a woven braided layer of synthetic yarns. More specifically, in the embodiment of FIG. 2, individual strands of synthetic strand or cord 30 are braided either around a core, indicated in general at 32, featuring multiple conductors 34 surrounded by a jacket 36. In the embodiment of FIG. 3, individual strands of synthetic strand or cord 40 are braided either around a core, indicated in general at 42, featuring a single power conductor 44 surrounded by a jacket 46. Conductors 34 and 44 may be replaced with members suitable for non-power applications, such as data and communication. As examples only, the members may include fiber optic cables or be constructed from a metal such as copper.

The jackets 36 and 46 may be extruded and, as examples only, constructed from materials that include polyvinylchloride (PVC) or nylon.

In both of the embodiments of FIGS. 2 and 3, the braided synthetic strands or cords 30 and 40 provide longitudinal support to the core. The core (32 or 42) is gripped by the radial pressure as a result of the longitudinal stress on the braided synthetic strands or cords 30 or 40.

The synthetic strands or cords 30 or 40 preferably are made of synthetic fibers such as those sold under the trade names TECHNORA (which is a para-aramid fiber made from co-polymers) or DYNEEMA, but alternative synthetic fibers offering high strength combined with light weight may be used. Synthetic fibers additionally having high heat capacity are desirable as well.

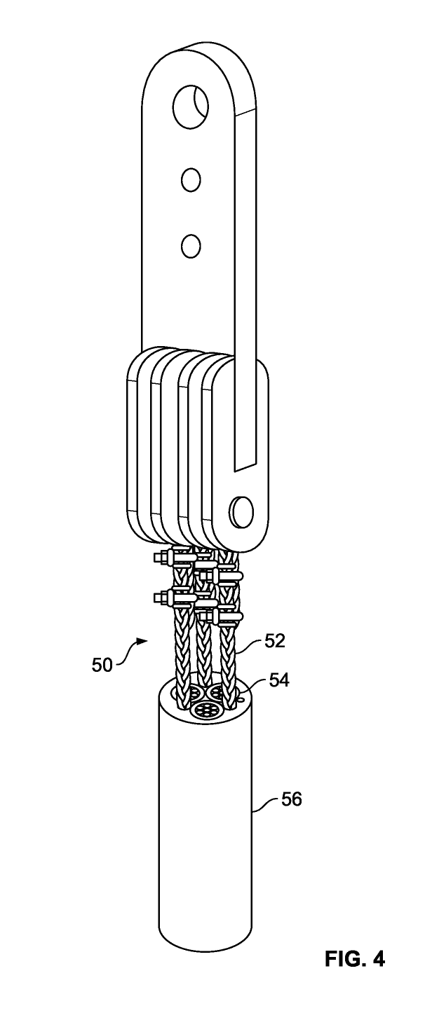

FIG. 4 illustrates an embodiment of the cable of the present invention where the cable, indicated in general at 50, has been redesigned to eliminate the heavy steel tensile members. The steel tensile members have been replaced with synthetic light weight strength or tensile members 52, which may be braided or woven (as shown in FIG. 4). This approach reduces the overall cable weight and in some cases reduces the cable diameter. High tensile synthetic strength members may be used with armored or unarmored designs of cable. In addition, while the embodiment of FIG. 4 illustrates multiple conductors 54, the synthetic tensile members 52 may be used with a single conductor design. Conductors 54 may be replaced with members suitable for non-power applications, such as data and communication. As examples only, the members may include fiber optic cables or be constructed from a metal such as copper.

The cable 50 of FIG. 4 is provided with an insulating jacket 56. The jacket 56 may be extruded and, as examples only, constructed from materials that include polyvinylchloride (PVC) or nylon.

The tensile members 52 are also preferably constructed from synthetic fibers such as those sold under the trade names TECHNORA or DYNEEMA, but alternative synthetic fibers offering high strength combined with light weight may be used. Synthetic fibers additionally having high heat capacity are desirable as well.

While the preferred embodiments of the invention have been shown and described, it will be apparent to those skilled in the art that changes and modifications may be made therein without departing from the spirit of the invention.

What is claimed is:

1. A cable comprising;
a) a core;
b) a braided synthetic material generally surrounding the core and adapted to serve as a tensile member so as to longitudinally support the core when the cable is used in vertical applications.

2. The cable of claim 1 wherein the core includes multiple power conductors.

3. The cable of claim 1 wherein the core includes a single power conductor.

4. The cable of claim 1 wherein the core is gripped by radial pressure from the braided synthetic material as a result of longitudinal stress acting on the braided synthetic material when the cable is used in vertical applications.

5. The cable of claim 1 wherein the braided synthetic material includes a para-aramid fiber made from co-polymers.

6. The cable of claim 1 wherein the core includes a jacket surrounding a conductor.

7. The cable of claim 6 wherein the jacket is made of a material that includes polyvinylchloride.

8. The cable of claim 6 wherein the jacket is made of a material that includes nylon.

9. The cable of claim 1 wherein the core includes communication members.

10. The cable of claim 1 wherein the core includes data members.

11. A cable comprising a core including a synthetic tensile member adapted to longitudinally support the core when the cable is used in vertical applications.

12. The cable of claim 11 wherein the core includes multiple power conductors.

13. The cable of claim 11 wherein the core includes a single power conductor.

14. The cable of claim 11 wherein the synthetic tensile member is braided.

15. The cable of claim 11 wherein the synthetic tensile member is woven.

16. The cable of claim 11 wherein the synthetic tensile material includes a para-aramid fiber made from co-polymers.

17. The cable of claim 11 wherein the core includes a jacket surrounding the synthetic tensile member.

18. The cable of claim 17 wherein the jacket is extruded.

19. The cable of claim 11 wherein the core includes communication members.

20. The cable of claim 11 wherein the core includes data members.
